(19) United States
(12) Patent Application Publication
(10) Pub. No.: US 2006/0026238 A1
(43) Pub. Date: Feb. 2, 2006

(54) Method of composing and sending e-mails with separate messages to copy recipients

(76) Inventor: Michael Schwarz, High Falls, NY (US)

Correspondence Address: Michael Schwarz, 280 Mohonk Road, High Falls, NY, 12440, US

(21) Appl. No.: 10/900,654

(22) Filed: Jul. 28, 2004

(51) Int. Cl. G06F 15/16

(52) U.S. Cl. 709/206

(57) ABSTRACT

An e-mail system provides the ability to compose, send and receive messages using a personal computer. The user creates a primary message, to be sent to primary message recipients, with or without attachments. The user can also create copy messages to be sent to copy message recipients. Attachments can be included in the copy messages. The copy messages are separate from the primary message and are only sent to the copy message recipients. The same applies to any attachments included with the copy messages. The primary message is sent to primary and copy message recipients. The copy messages can be sent at the same time as the primary message or saved for editing and sending later.

### BACKGROUND

This invention relates to e-mail systems. Commercial examples of e-mail systems are Outlook®, Outlook Express and Eudora®, that allow the user to compose, send and receive messages using a personal computer, using dedicated software. Web-based systems such as Yahoo!® and Hotmail® allow users to compose, send and receive messages using a web browser.

The following operations are commonly performed by e-mail systems:
receiving e-mail: this involves receiving an e-mail sent by someone else. The e-mail is typically placed in an in-box and opened when the user wants to read it.
composing e-mail: this involves writing a message and selecting or typing one or more address(es) of proposed recipients.
sending e-mail: this involves sending the composed e-mail to the recipient(s) addresses. Sending e-mail may involve a variety of different operations. An original, composed e-mail may be sent to a recipient address. An e-mail that has been received from someone else may be sent on to another recipient address. The user may reply to an e-mail that has been received.

Once the message is composed (whether as part of an original message or a message to be forwarded or replied to), the system allows the message to be sent.

The user may select the recipient e-mail addresses in a variety of ways. For example, he or she may type in an e-mail address from memory, choose it from an electronic address book, or type in a few characters of the address and allow the e-mail system to choose a recipient address automatically from an electronic address book. The recipient address may be the address of a primary recipient, or someone being sent a copy of what is being sent to the primary recipient (referred to here as the “copy recipient”). The e-mail system typically allows the sender of an e-mail to choose to allow the direct recipient to know the identity of the person being sent a copy or not know that identity. In the former case, the e-mail sent to the secondary recipient is known as a “cc” or “carbon copy” and in the latter case, it is known as a “bcc” or “blind carbon copy.”

When the copy recipient receives the message, he or she receives exactly what was sent to the primary recipient. This can lead to a lot of unexplained e-mails being received by copy recipients. This is because copy recipient receives only what the primary recipient receives—and no additional or explanatory messages.

The following is an example that demonstrates this shortcoming in the prior art:

Attorney Aardvark represents Plaintiff Paul against Defendant Peter. He wants to send an e-mail to Defendant Paul and send a copy to Plaintiff Paul. He would like to explain to his client, Paul, what certain items in the letter mean and why he phrased them the way he did. He would also like to send an invoice to his client. He would also like to tell Associate Beaver that he should look out for a reply from Defendant Peter, and set out a strategy for dealing with any response that might come in from Peter. Using an e-mail system of the prior art, Attorney Aardvark had to send his e-mail to Defendant Peter and then send separate e-mails to Plaintiff Paul and to Associate Beaver.

The following is another example. Manager Collie is required by President Shepherd, to appraise his team members Sheep A-X. Once the team members have been appraised, cuts have to be made to the payroll, based on the performance appraisals. Manager Collie is required to send each of Sheep A-X an appraisal, with a copy to President Shepherd. Using a system of the prior art, Collie must separately tell Shepherd which team members will be kept and which will be laid off. Collie could not send confidential recommendations to Shepherd at the same time as he sent the appraisals to Sheep A-X.

It is an object of this invention to provide a way of allowing the sender of an e-mail to send a message to a primary recipient (as it is done in the prior art), send a copy of the e-mail to the copy recipient and include with the copy recipient's copy, a separate note directed to the copy recipient or a select group of copy recipients, but not to the primary recipient. In the second example, using the present invention, Collie can send an appraisal to Sheep A, copy to Shepherd, with an note to Shepherd saying Sheep A should be kept on the payroll. Collie can send an appraisal to Sheep B, copy to Shepherd, with a note to Shepherd saying that Sheep B is a candidate for redundancy. It is also an object of the invention to allow a sender to add the same or different attachments to primary messages and copy messages.

U.S. Pat. No. 6,628,306 (which is incorporated herein by reference) discloses an e-mail system which allows the sender to send e-mails with attachments to primary recipients but leave the attachments off the e-mails sent to copy recipients. That system requires the sender to decide whether he should include the attachment with the message to the copy recipient. It therefore provides the opposite of what is needed. Using the present invention, the sender does not necessarily eliminate an attachment going to the copy recipient. The sender can also send different attachments to primary and copy recipients.

U.S. Pat. No. 6,247,045 (which is incorporated herein by reference) discloses an e-mail system which allows the user to create a single message which include sections that are meant for some recipients but not others. All messages for all recipients are contained in that single message, different parts of which the user designates to go to different recipients. Using the present invention, the user can write his/her main message in a normal way and decide who to send it to. He or she can also send copies of it to others with separate messages (and attachments) with those copies rather than having them all in a single message, which is then broken up.

### SUMMARY OF THE INVENTION

The invention includes a method of composing and sending e-mails. It allows the user to create a primary message in a primary message window and to select recipients for the primary message. A copy message is created in a copy message window, separate from the primary message window and the recipients for that copy message are selected. A primary e-mail addressed to the one or more primary message recipients is formed. The primary e-mail includes the primary message, but not the copy message. The copy-mail addressed to the one or more copy message recipients is formed. The copy e-mail includes the copy message and the primary message. The primary e-mail is sent to the one or more primary message recipients. The copy e-mail is sent to the one or more copy message recipients. Additional copy messages can be created and sent to additional copy message recipients. The same or different attachments can be sent to primary and copy message recipients.

### BRIEF DESCRIPTION OF THE DRAWINGS

FIG. 1 is a flowchart showing the basic method of the invention.

FIG. 2 is an illustration of a the primary message screen generated by a computer programmed in accordance with the invention:

FIG. 3 is an illustration of a cc copy message screen generated by a computer programmed in accordance with the invention;

FIG. 4 is an illustration of a cc copy message screen generated by a computer programmed in accordance with the invention;

FIG. 5 is a flowchart showing details of the send operation.

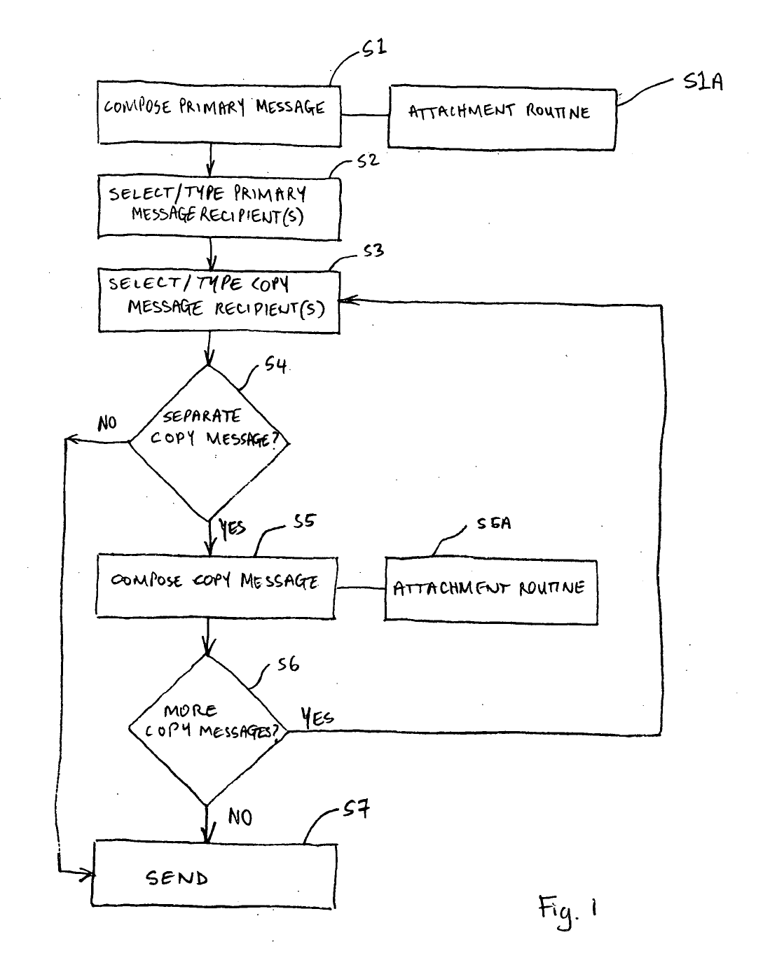

### DETAILED DESCRIPTION OF THE PREFERRED EMBODIMENT

The following description is of the preferred embodiment of the invention. It is intended to be illustrative but not limiting of the invention.

The invention is implemented by means of a suitably programmed computer. A person of ordinary skill in the art will recognize that the steps of the invention as set out in this description need not be carried out in the exact order in which they appear and some steps can be combined or split into smaller steps.

The following terms have the following meanings unless the context requires otherwise:

“Primary message”—an e-mail message for sending to a primary recipient, composed in the primary message window.

“Copy message”—an e-mail message for sending to a secondary recipient, composed in the copy message window, which is sent with the message sent to the primary recipient, which informs the secondary recipient that the primary recipient has been sent the primary message. A copy message includes at least part of the primary message. The primary message does not include the copy message.

At S1, the sender composes the primary message 2 by typing it or pasting it into primary message window 10. In our examples, this primary message is the demand letter Attorney Aardvark sends to Defendant Peter, or the note to Sheep A, containing a summary of his appraisal. If he so desires, the sender may attach a document 4 as part of the primary message, as shown in Attachment Routine S1A. This is done in a known way by clicking on attachment icon 12, which results in the attachment of attachment 4. In our examples, the attachment may be evidence of wrongdoing that Attorney Aardvark sends to the Defendant Peter or the actual employee performance appraisal form that Manager Collie sends to Sheep A, which was summarized in the message.

At S2, the sender inputs selects the primary message recipient e-mail address(es) 6 (by typing them, or choosing them from an address book, or by typing the first few letters and allowing the computer to choose them from an address book in a well known way). The address(es) are shown in primary message recipient window 14. At the end of S2, primary e-mail 32 has been formed.

At S3, the sender decides if he wants to cc or bcc a copy recipient or recipients and selects the copy recipient e-mail address(es) 8 as described above in relation to the primary message recipients. At S4, the sender can choose to send a cc or bcc without a separate note (or copy message) by clicking on cc or bcc icons 16 or 18, or the sender can choose to send a cc or bcc with a copy message by clicking on “cc note” icon 20 or “bcc note” icon 22. Another way of doing this would be to eliminate the “cc note” and “bcc note” icons 20 and 22 and instead show a pull down menu when the normal cc or bcc icons 16 are clicked. The pull down menu then offers the choice of cc with note or bce with note, or conventional cc or bce options.

If the sender has opted to include a copy message to the copy recipient(s), he composes a separate copy message 24 (in copy message window 25) at S5. The copy message is either typed directly into copy message window 25 or pasted from an existing document or both.

This copy message is not included in the text of primary message 2. In our examples, the copy message will be the note Attorney Aardvark sends to his client Paul, explaining the letter to Defendant Peter, or the note Manager Collie sends to President Shepherd giving his views on Sheep A's performance. It is also possible to add an attachment for the copy message recipient, using S5A, the attachment routine. This is done by clicking on attachment icon 26, thereby attaching attachment 28. In our examples, the attachment is an invoice from the attorney to his client. Cc copy e-mail 30 is thus formed. The attachments need not be the same as any attached to the primary message and need not be sent to the primary message recipient(s).

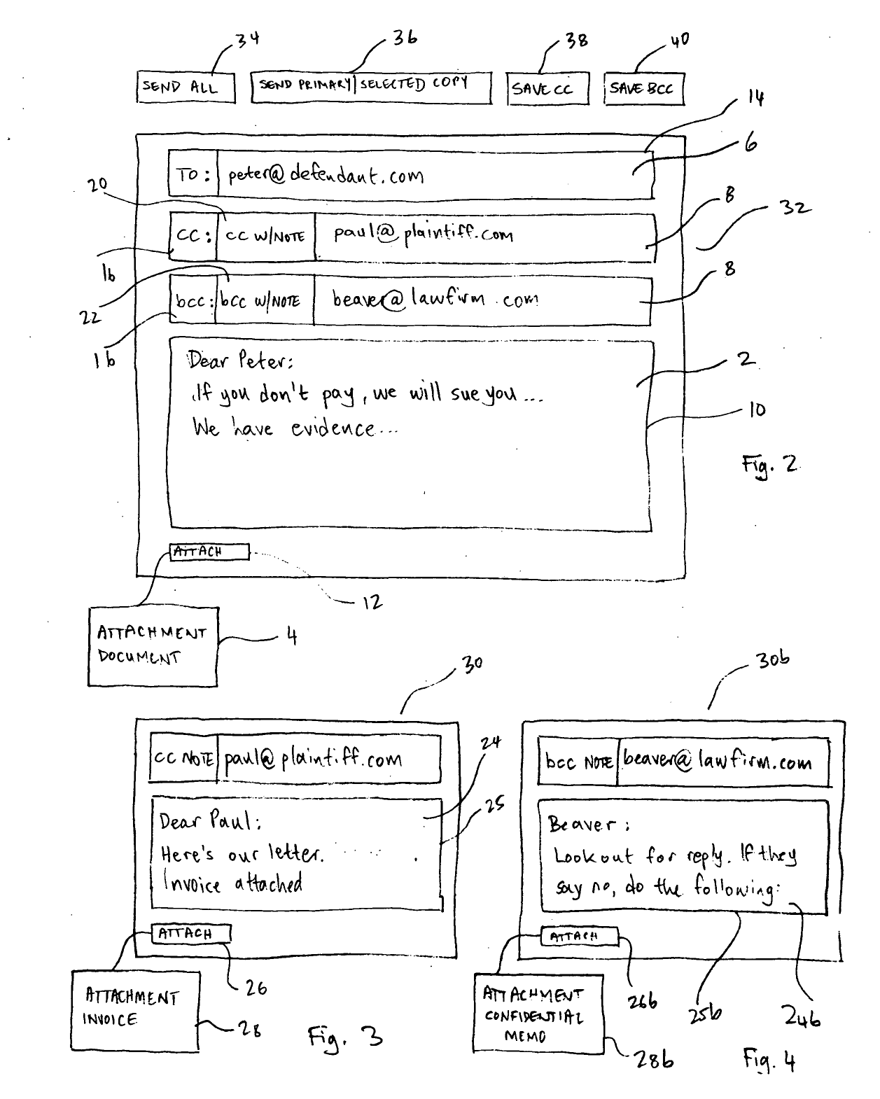

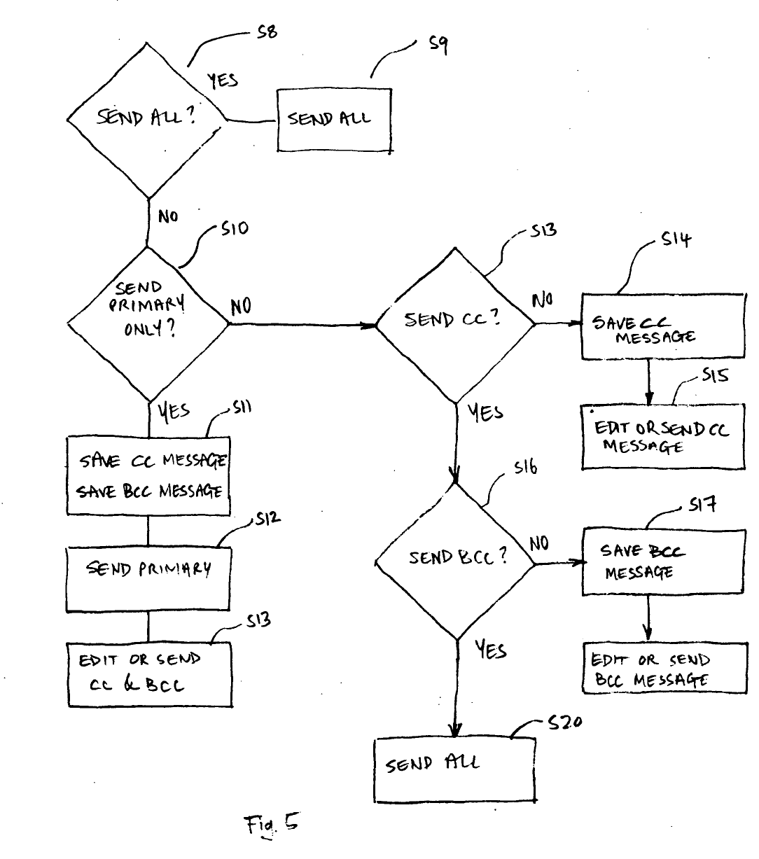

The same steps are carried out in order to select a bce copy recipient, which is shown in FIG. 3 with the same numerals as used in FIG. 2, but followed by the letter “b.” The bee copy recipients in our examples may be the accounting department of the law firm and the human resources department of the company for which Collie and Shepherd work.

At S6, the sender has the option of sending or adding another copy recipient or recipients. If another copy recipient is to be added, the sender is returned to S3, where such copy recipients can be typed in or selected. At S4, the sender can compose a new message for any new copy recipients. This allows the sender to send different notes (and different attachments) to different copy recipients, for example Plaintiff Paul and Associate Beaver get different messages in our hypothetical case.

At S7 the primary and copy messages are sent. S7 can be broken down into smaller steps which give the sender more options. At S8, by clicking on “send all” icon 34, the sender can send the primary e-mail and the copy e-mail(s) (see S9). The sender can opt to send only the primary e-mail and selected copy e-mails, at S10 by clicking on “send primary/selected copies only” icon 36. This results in the copy e-mails being saved at S11 for editing and/or sending later at S13. The primary e-mail is sent at S12.

If the sender has opted not to send all e-mails, he has the option of saving copy e-mails. At S13, by clicking on “save cc” icon 38, the sender has the option of saving cc copy e-mails, which is done at S14. Such saved e-mails can be saved and edited and/or sent later at S11. This allows the user to change his/her mind about sending a copy or about its contents, even after the primary message has been sent. Clicking on “save cc” icon 38 will open a pull down menu, which allows the sender to select some or all of the cc copy e-mails for saving. Any cc copy e-mails that are not saved, are sent when the primary e-mail is sent. The same procedure is applied to bcc copy e-mails by clicking on “save bcc” icon 40, as shown in steps S16, S17 and S18. If the sender has not opted to not to save a copy e-mail, he can click on “send” icon 34 and send the primary and copy e-mails at S12 (i.e. by clicking on “send primary/selected copies only” icon 36). The foregoing can also be implemented by means of suitable pull down menus opened by clicking on send icon 34, thus eliminating the need for the separate icons 36 and 38.

Using this specification, a person of ordinary skill in the art will be able to program a computer to implement the invention in a variety of ways, without departing from the spirit of the invention.

I claim:

1. A method of composing and sending e-mails comprising the steps of:
creating a primary message in a primary message window;
selecting one or more primary message recipients, to receive the primary message;
creating a copy message in a copy message window, separate from the primary message window;
selecting one or more copy message recipients, to receive the copy message;
forming a primary e-mail addressed to the one or more primary message recipients, the primary e-mail including the primary message, but not the copy message;
forming a copy e-mail addressed to the one or more copy message recipients, the copy e-mail including the copy message and the primary message;
sending the primary e-mail to the one or more primary message recipients;
sending the copy e-mail to the one or more copy message recipients.

2. The method of claim 1 further comprising the steps of:
creating an additional copy message in a copy message window, separate from the primary message window;
selecting one or more additional copy message recipients, to receive the additional copy message;
forming an additional copy e-mail addressed to the one or more additional copy message recipients, the additional copy e-mail including the additional copy message and the primary message;
sending the additional copy e-mail to the one or more additional copy message recipients.

3. The method of claim 1 further comprising the step of:
attaching a primary attachment to the primary e-mail.

4. The method of claim 1 further comprising the step of:
attaching a copy attachment to the copy e-mail.

5. The method of claim 2 further comprising the step of:
attaching a an additional copy attachment to the additional copy e-mail.

6. A method of composing and sending e-mails comprising the steps of:
creating a primary message in a primary message window;
selecting one or more primary message recipients, to receive the primary message;
creating a copy message in a copy message window, separate from the primary message window;
selecting one or more copy message recipients, to receive the copy message;
forming a primary e-mail addressed to the one or more primary message recipients, the primary e-mail including the primary message but not the copy message;
forming a copy e-mail addressed to the one or more copy message recipients, the copy e-mail including the copy message and the primary message;
creating an additional copy message in a copy message window, separate from the primary message window;
selecting one or more additional copy message recipients, to receive the additional copy message;
forming an additional copy e-mail addressed to the one or more additional copy message recipients, the additional copy e-mail including the additional copy message and the primary message;
sending the primary e-mail to the one or more primary message recipients;
sending the copy e-mail to the one or more copy message recipients;
sending the additional copy e-mail to the one or more additional copy message recipients.

7. The method of claim 6 further comprising the step of:
attaching a primary attachment to the primary e-mail.

8. The method of claim 6 further comprising the step of:
attaching a copy attachment to the copy e-mail.

9. The method of claim 6 further comprising the step of:
attaching a an additional copy attachment to the additional copy e-mail.
